(19) United States
(12) Patent Application Publication
(10) Pub. No.: US 2005/0208281 A1
(43) Pub. Date: Sep. 22, 2005

(54) Method for production of a glazed piece provided with a multi-layer coating

(76) Inventors: Daniel Decroupet, Jumet (BE); Jean-Michel Depauw, Jumet (BE)

Correspondence Address: Piper Rudnick, 1200 Nineteenth Street NW, Washington, DC, 20036-2412, US

(21) Appl. No.: 10/517,868

(22) PCT Filed: Jun. 13, 2003
(86) PCT No.: PCT/EP03/50227

§ 371 Date: Dec. 16, 2004

(30) Foreign Application Priority Data
Jun. 17, 2002 (EP) 020774352

(51) Int. Cl. B32B 7/02

(52) U.S. Cl. 428/216

(57) ABSTRACT

The invention relates to a method for production of a glazed piece provided with a multi-layer coating deposited by cathodic atomization, a glazed piece provided with a multi-layer coating and a crowned or tempered glazed piece provided with a multi-layer coating. According to the invention, at least one first transparent dielectric layer is deposited, followed by a functional layer based on a material which reflects infra-red radiation. A first protective layer is then deposited with at most 3 nm of a material having an electronegativity difference to oxygen of less than 1.9, followed by deposition of a second protective layer, with at most 7 nm of a material with an electronegativity difference to oxygen of greater than 1.4. At least one second transparent dielectric layer is then deposited. The invention is particularly advantageous for the formation of glazed pieces with low emmissivity or for solar protection which are crowned or tempered after deposition of the coating.

The invention relates to a method for the production of a glazing provided with a multilayer coating, said multilayer coating being deposited on a glass substrate by cathodic sputtering at reduced pressure and being capable of undergoing a thermal treatment at elevated temperature such as a bending, annealing or thermal toughening or thermal tempering operation, and also relates to a glazing provided with a multilayer coating capable of undergoing a thermal treatment at elevated temperature.

The glazing units provided with a multilayer coating referred to in the present invention are used to improve the thermal insulation of large glazed surfaces and thus reduce energy losses and the costs of heating in a period of cold weather. The multilayer coating is a coating with low emissivity, which reduces the heat loss through high wavelength infrared radiation. These glazing units can also be used as solar protection to reduce the risk of excessive overheating as a result of sunlight in an enclosed space that has large glazed surfaces, and thus reduce the air-conditioning utilised in summer.

These glazing units are intended for fitting in buildings as well as in motor vehicles. It is sometimes necessary to subject the glazing to a mechanical reinforcement operation, such as thermal toughening or thermal tempering, to improve its resistance to mechanical stresses. In the automotive sector, for example, it is also often necessary to bend the glazing, in particular for shaping in the form of a windscreen.

In the processes for the production and shaping of glazing units, there are some advantages to conducting these toughening and bending operations on the substrate when it is already coated, instead of coating a substrate that has already been shaped. However, these operations are performed at a relatively elevated temperature, at which the coating tends to deteriorate and lose its optical properties and its properties with respect to infrared radiation.

It has been found that the deterioration of the multilayer coating is sometimes due to oxidation of the layer intended to reflect the infrared radiation during the thermal treatment. A solution that is often proposed in an attempt to resolve this problem and form a glazing, which has the required characteristics after thermal treatment, is to provide a sacrificial metal layer expediently disposed inside the coating. This sacrificial metal oxidises in place of the layer intended to reflect the infrared radiation and protects it.

An example of this solution is proposed in the patent EP 233 003 B1, which describes a lamination of silver-based layers as infrared reflector enclosed by tin oxide. This patent provides an additional metal layer chosen from aluminium, titanium, zinc and tantalum disposed on the silver layer and possibly also below the silver. This additional metal captures the oxygen and oxidises during the thermal treatment, thus protecting the silver from oxidation.

In its metal form, the additional metal is absorbent, and this tends to reduce the light transmission of the coating. With a view to obtaining a finished product with high light transmission, this patent therefore proposes to use just sufficient metal to protect the silver layer throughout the thermal treatment, while preventing any absorbent additional metal from remaining in the finished product. The quantity of additional metal to be provided therefore depends on the temperature and the duration of the thermal treatment.

With the solution proposed by the patent EP 233 003 B1, it is difficult to obtain a product of constant quality over a long production period, and in the case of glazing of complex shape it can be difficult to obtain a uniform quality over the entire surface. Moreover, when it is necessary to bend or toughen glazing units with different thicknesses or shapes, the temperature and time conditions of the thermal treatment must be modified, and therefore it is necessary to change the thickness of the additional metal to adapt to these modifications of treatment conditions.

The invention relates to a method for the production of a glazing provided with a multilayer coating, said multiplayer coating being deposited on a glass substrate by cathodic sputtering at reduced pressure, characterised in that at least a first transparent dielectric layer is deposited on the substrate followed by the deposit of a functional layer based on an infrared reflective material, that in an atmosphere containing 20% oxygen at maximum, deposited on said functional layer is a first protective layer with a geometric thickness of 3 nm at maximum and composed of a material, of which the electronegativity difference from oxygen is less than 1.9 and of which the electronegativity value is less than that of said infrared reflective material, followed by the deposit, in an atmosphere containing 50% oxygen at maximum, of a second protective layer with a geometric thickness of 7 nm at maximum and composed of a material, of which the electronegativity difference from oxygen is greater than 1.4, and that at least a second transparent dielectric layer is then deposited.

The electronegativity values of elements such as those used in the present invention are mean values classed according to the Pauling scale, and are obtained from thermochemical data. For clarification purposes, the electronegativity values are listed below for some elements as follows:

| | | | | | | | |
|---|---|---|---|---|---|---|---|
| Ag | 1.93 | Au | 2.54 | Pd | 2.20 | Pt | 2.28 |
| Al | 1.61 | O₂ | 3.44 | Si | 1.90 | Ti | 1.54 |
| Cr | 1.66 | Ni | 1.90 | Cu | 1.65 | Zn | 1.81 |
| Zr | 1.33 | Sn | 1.96 | Sb | 2.05 | Pb | 2.33 |
| Bi | 2.02 | Ta | 1.5 | Hf | 1.3 | In | 1.78 |

The purpose of the transparent dielectric layers is firstly to reduce the light reflection of the coating by interference effect, since the functional layer based on a material which reflects the infrared radiation tends to also reflect visible radiation. They favour the formation of a glazing reflecting the infrared with a high light transmission. These transparent dielectric layers also provide some protection to the functional layer against external physical or chemical stresses, and the layer deposited on the substrate contributes favourably to adhesion of the coating to the glazing. These transparent dielectric layers also have an effect on the hue in transmission and reflection of the product obtained.

According to the invention, the material of the first protective layer deposited directly onto the functional layer has a limited avidity with respect to oxygen, since the electronegativity difference from oxygen is less than 1.9, while also retaining a higher avidity with respect to oxygen than the infrared reflective material to prevent oxygen from passing to said material. This is contrary to the teaching of the prior art, since this teaches us that the functional layer must be protected by a layer with an avidity towards oxygen such as Ti or Ta, which will absorb the oxygen to prevent the functional layer from oxidising and thus losing its essential properties.

We have found that, surprisingly, the invention provides a production method, which favours the formation of a glazing of stable and uniform quality. The method according to the invention enables a glazing provided with a multilayer coating to be obtained, which is particularly suitable for supplying a production line, where it must be subjected to a thermal treatment at elevated temperature, such as a bending, annealing or thermal toughening operation. In fact, even if the time and temperature conditions of the thermal treatment were to change appreciably during the course of production or from one production cycle to another, these changes would have considerably less influence on the optical and thermal properties of the finished glazing than according to the prior art, and indeed have no influence if the structure of the coating is chosen appropriately. Therefore, the method according to the invention removes the necessity to modify the structure of the coating in accordance with the characteristics of the thermal treatment which the glazing must undergo.

Another advantage of the invention is that by appropriate selection of the transparent dielectric layers, the method according to the invention allows a glazing provided with a multilayer coating to be obtained, in which there is little or insignificant change in the optical properties during the thermal treatment, and therefore a glazing that has undergone a thermal treatment could be placed beside a glazing that has come from the same production method according to the invention, but has not undergone thermal treatment without being aesthetically undesirably different.

The reason for this surprising effect is not fully understood. However, it is thought that the adjoining of the first and second protective layers to the functional layer in the conditions specified by the invention plays a fundamental role. It is thought in particular that since the material of the first protective layer has a relatively low avidity with respect to oxygen, its degree of oxidation does not vary suddenly, it does not reach saturation too quickly and forms a stable screen for the functional layer. Because it is thin, since its thickness does not exceed 3 nm, the first protective layer can have a limited impact on the absorption of the coating and it is easier to obtain a level of oxidation that is sufficient for a good transparency. This first protective layer therefore plays a stabilising role on the properties of the coating. Thus, the material of the second protective layer has a sufficient avidity with respect to oxygen to have a tendency to retain its oxygen and not be separated from it too easily, and this allows a small thickness to be used for the first protective layer.

Preferably, the first protective layer is composed of a material, of which the electronegativity difference from oxygen is less than 1.8 and preferably less than 1.7. By adopting such electronegativity differences with respect to oxygen, there is a tendency to reinforce the stabilising effect of the first layer.

Preferably, the second protective layer is composed of a material, of which the electronegativity difference from oxygen is greater than 1.6 and preferably greater than 1.8. This reinforces the attraction of the second layer to oxygen such that it more readily retains its oxygen during a thermal treatment, thus preventing diffusion of the oxygen towards the functional layer.

Preferably, the electronegativity value of the material of the first protective layer is at least 0.05 less than that of the infrared reflective material. This reduces the risk of oxygen passing from the first protective layer towards the functional layer during a thermal treatment.

Preferably, the material of the second protective layer has an electronegativity value at least 0.1, and advantageously at least 0.2, less than the electronegativity value of the material of the first protective layer.

It has been found that the fact that a material, wherein the electronegativity value is less than that of the first protective layer, is used for the material of the second protective layer reinforces the beneficial effect of the invention. It is thought that the difference between the two materials reduces the risk of oxygen passing towards the functional layer during a thermal treatment because the second protective layer has a higher avidity towards oxygen than the first protective layer and because the second protective layer therefore tends to more readily retain oxygen.

The functional layer based on an infrared reflective material is a metal layer, for example, based on aluminium, copper, zinc, nickel or a precious metal such as gold, silver, platinum or palladium. The infrared reflective material is preferably a silver-based material. Silver is a material that is well suited to use as functional layer, since it has excellent infrared reflective properties in relation to its sale price and ease of use in devices for layer deposition by cathodic sputtering at reduced pressure. It can be pure silver, an alloy of silver, e.g. with copper, aluminium, or of silver with a small quantity, in the order of 0.5 to 5%, of palladium, copper, aluminium, gold or platinum, and preferably palladium.

The first protective layer can be based on a material selected, for example, from zinc, copper, nickel, chromium, indium, stainless steel or tin and their alloys, in metal or sub-oxidised state.

Preferably, the first protective layer is Ni-based and advantageously an NiCr-based alloy. An alloy which is particularly well suited is NiCr 80/20 alloy. The Ni alloy can be deposited in pure metal state or in sub-oxidised or nitrided state or in the form of an oxynitride. It has been found that this material was particularly well suited to forming a stabilising first protective layer with a very small thickness that benefits the formation of a glazing with high light transmission.

Preferably, the material of the second protective layer is selected from titanium, aluminium or tantalum and their alloys, advantageously titanium. These elements largely retain oxygen and form transparent oxides, and are therefore most appropriate as the second protective layer for the aims of the invention.

Preferably, the first protective layer is deposited with a thickness in the range of between 0.5 nm and 2.5 nm, advantageously between 0.5 nm and 2 nm, and most favourably between 0.6 nm and 1.5 nm. This provides the best stabilising effect, which was discussed above.

Preferably, the second protective layer is deposited with a thickness in the range of between 2 nm and 6 nm. It has been found that this range of thicknesses for the material of the second protective layer was favourable for the retention of oxygen and the protection of the functional layer.

The material of the second protective layer can be deposited in metal or sub-oxide form working from a metal target in a neutral or slightly oxidising atmosphere. It can also be deposited from a ceramic target formed by a metal oxide in a relatively neutral atmosphere, e.g. one containing 10 to 20% oxygen, the rest being formed by argon. It is advantageously then substantially totally oxidised by the oxidising plasma during the deposition of a metal oxide forming part of the second transparent dielectric layer, so that it is transparent after deposition, which facilitates the formation of a high light transmission. After the whole coating has been deposited, the second protective layer is advantageously formed from TiO₂, Ta₂O₅ or Al₂O₃.

If the following layer is a dielectric layer deposited in an active atmosphere of nitrogen or a nitrogen-oxygen mixture, the second protective layer could be a nitride or oxynitride, for example, after deposit of the coating such as AlN or AlnₓO_{y}, which are transparent.

If the aimed objective with respect to the final optical properties of the produced glazing is a lower light transmission, the second protective layer can remain partially absorbent and contain absorbent compounds such as TiN or CrN or reflective compounds such as ZrN.

The elements specified for the second protective layer have a higher avidity for oxygen than nitrogen. Even when they are partially or totally nitrided, they retain an avidity with respect to oxygen and are therefore capable of capturing oxygen and retaining it.

However, preferably, the material of the second protective layer is deposited in metal or sub-oxidised form, and it is oxidised completely by the oxidising plasma of the deposit of the following layer. It is thus possible to deposit an oxide from a metal target to form the second transparent dielectric layer.

Preferably, the second transparent dielectric layer is based on a different element from the material of the second protective layer. This facilitates the choice of elements that are specifically better suited to the different roles played by the two different layers.

The first and second transparent dielectric layers can be formed by any transparent oxide, carbide, oxycarbide, nitride or oxynitride used in a manner known per se in the domain of coatings formed by cathodic sputtering at reduced pressure. In particular, the following may be cited: nitrides, oxynitrides or oxides of silicon, chromium, zirconium or aluminium; carbides or oxycarbides of titanium, tantalum or silicon; carbides or oxycarbides of chromium; oxides of tin, zinc, titanium, bismuth, magnesium, tantalum, niobium, indium; and also the alloys of these different elements. Some elements can also be advantageously doped, such as zinc or silicon oxide doped with aluminium, for example.

Preferably, at least one of the first and second transparent dielectric layers contains a zinc-based metal oxide. When silver is used as infrared reflective material, this metal oxide has a beneficial effect of passivating the silver, and this makes the functional layer more resistant to chemical degradation, for example, during a thermal treatment. Zinc is also a metal which is well suited to cathodic sputtering at reduced pressure.

Preferably, said metal oxide is an oxide of a zinc- and tin-based alloy. As indicated above, zinc oxide is particularly advantageous. However, it has a tendency to become porous with a large thickness. A zinc-tin alloy is particularly advantageous, since it reduces this tendency. Advantageously, at least one of the first and second dielectric layers contains two layers of oxide of zinc- and tin-based alloys in different proportions. This enables the proportion of zinc in the alloy to be adapted expediently so that the dielectric the closest to the functional layer has the highest concentration of zinc to favour the beneficial effect of zinc, and so that the other portion of the dielectric has a lower concentration of zinc to reduce the risk of porosity of the layer.

Advantageously, each of the first and second dielectric layers contains a zinc-based metal oxide. The beneficial effect of zinc is thus better assured for the entire coating.

Only a single functional layer has been referred to in the above. This type of coating enables glazing units with low emissivity that are very useful for thermal insulation in periods of cold weather to be easily obtained. By making the functional layer thicker, it is also possible to obtain a glazing for increased solar protection. However, when it is required to increase the solar protection while retaining a very high transmission with a specific aesthetically appealing appearance, as is generally the case for a windscreen in a motor vehicle, it is necessary to deposit two, even three, functional layers. Therefore, in a preferred embodiment of the method according to the invention, at least two functional layers based on an infrared reflective material are deposited, each followed by the deposit of at least one intermediate dielectric layer between said functional layers.

Advantageously, the multilayer coating is terminated by depositing a thin final protective layer based on chromium, molybdenum, stainless steel, nickel or titanium, as well as their alloys, and preferably based on titanium. This provides an effective protection against scratches.

The invention also covers a method for the production of a bent or toughened glazing provided with a multilayer coating, characterised in that a substrate coated according to the method described above is then subjected to a bending or toughening operation.

According to another aspect, the invention relates to a glazing provided with a multilayer coating, characterised in that it comprises a glass substrate, on which is deposited at least one functional layer based on an infrared reflective material, the functional layer or at least one of the functional layers being enclosed by at least one transparent dielectric layer, and that on its face opposite the substrate and directly in contact therewith, said functional layer is covered by a first protective layer with a geometric thickness of 3 nm at maximum and composed of a metal- or semi-metal-based material in metal, nitrided or sub-oxidised form, of which the electronegativity difference from oxygen is less than 1.9 and of which the electronegativity value is less than that of the infrared reflective material, followed by a second protective layer with a geometric thickness of 7 nm at maximum and composed of a material based on metal or semi-metal in substantially totally oxidised form, of which the electronegativity difference from oxygen is greater than 1.4 and which is different from the material of the transparent dielectric layer directly adjoining it.

According to a further aspect, the invention relates to a bent or toughened glazing provided with a multilayer coating, characterised in that it comprises a glass substrate, on which is deposited at least one functional layer based on an infrared reflective material, the functional layer or at least one of the functional layers being enclosed by at least one transparent dielectric layer, and that on its face opposite the substrate and directly in contact therewith, said functional layer is covered by a first protective layer with a geometric thickness of 3 nm at maximum and composed of a metal- or semi-metal-based material in oxidised or sub-oxidised form, of which the electronegativity difference from oxygen is less than 1.9, followed by a second protective layer with a geometric thickness of 7 nm at maximum and composed of a material based on metal or semi-metal in substantially totally oxidised form, of which the electronegativity difference from oxygen is greater than 1.4 and which is different from the material of the transparent dielectric layer directly adjoining it. According to this aspect of the invention, “bent or toughened glazing provided with a multilayer coating” should be understood to mean that the thermal treatment of toughening or bending took place after the operation of depositing the layer, therefore it is a substrate that is already coated which has been subjected to the toughening or bending process.

The features discussed above relating to structure, composition and sequence of the different layers with respect to the method of the invention also apply to the details relating to the glazing units before and after thermal treatment.

Preferred practical embodiments of the invention shall now be described by means of some non-restrictive examples.

### EXAMPLE 1

A sheet of ordinary soda-lime glass of 2 m by 1 m and 4 mm thick is placed in a device for cathodic sputtering at reduced pressure of the magnetron type manufactured by BOC. It firstly passes into a first sputtering chamber, in which the atmosphere is formed from 20% argon and 80% oxygen at a greatly reduced pressure in relation to atmospheric pressure. A first transparent dielectric layer is firstly deposited on the glass sheet. Using a cathode of a zinc-tin alloy comprising 53% zinc and 48% tin, a 20 nm thick layer of ZnSnOₓ is firstly deposited. In a similar atmosphere, on the ZnSnOₓ another layer of ZnSnOₓ 12 nm thick is then deposited working from a target of a zinc-tin alloy formed from 90% zinc and 10% tin. The glass sheet then passes into another sputtering chamber where the atmosphere is formed from 100% argon. A functional layer formed from 10 nm of silver working from a practically pure silver target, is deposited on the ZnSnOₓ layer. In this same atmosphere, a first protective layer is then deposited on the silver, in the present example this first protective layer is a 1 nm thick layer of NiCr working from a target of an alloy formed by 80% Ni and 20% Cr. In an atmosphere of 10% oxygen and 90% argon, a second protective layer is then deposited on the NiCr layer, here formed by a 5 nm thick TiOₓ layer working from a ceramic target of TiOₓ, x being in the range of between 1.6 and 1.9. In another chamber where the atmosphere is oxidising, i.e. 80% oxygen and 20% argon, a second transparent dielectric layer is then deposited on the TiOₓ layer. For this, a 10 nm thick layer of ZnSnOₓ working from a metal target of an alloy of ZnSn formed from 90% Zn and 10% Sn is firstly deposited. It should be noted that the oxidising atmosphere of the plasma completes the oxidation of the lower layer of TiOₓ so that at the end of the process of depositing the ZnSnOₓ layer, the titanium is essentially completely oxidised to form a compact barrier of TiO₂. Deposit of the second transparent dielectric layer is followed by the deposit of a 15 nm thick ZnSnOₓ layer in an atmosphere of 80% oxygen and 20% argon working from a target of an alloy of ZnSn formed by 52% Zn and 48% Sn. The coating is then finished by the deposit of a final protective layer of 3 nm of TiOₓ. It should be noted that all the ZnSnOₓ layers are sufficiently oxidised to be as transparent as possible.

When it exits from the layer depositing device, the freshly coated glazing has the following properties when viewed from the layer side:
TL=80%; L=23; a=−2; b=−13; emissivity=0.08.

The coated glazing is subjected to a thermal tempering operation, during which it is subjected to a temperature of 690° C. for 4 minutes, then cooled suddenly by jets of cold air. During this thermal treatment, the NiCr layer oxidises sufficiently to be transparent while also forming an effective and stable screen to protect the silver. It seems that the TiO₂ layer in turn retains its oxygen since, as will be seen below in the properties of the coating after toughening, the silver layer is not oxidised in spite of the very thin thickness of the NiCr screen. Therefore, the combination of the first and second protective layers has a particularly beneficial effect with respect to the functional layer of silver.

After this treatment, the coated and toughened glazing has the following properties when viewed from the layer side:
TL=88%; L=24.4; a=−1.6; b=−8.6; emissivity=0.05;
   the electrical surface resistivity of the coating is 3.8 ohm per square and the coefficient k (U value) is less than 1.2 W/m².K.

This coated glazing is then assembled as double glazing with another clear glass sheet of 4 mm, the coating being arranged on the side of the inside space of the double glazing. The following properties are noted when the double glazing is viewed from the layer side disposed in position 3, i.e. one sees firstly the clear glass sheet without the layer, then the glazing provided with the coating viewed from the layer side:
TL=79.2%; L=34.5; a=−1.4; b=−4.
   In this example, as in the following examples unless indicated otherwise, the light transmissions (TL) are established with respect to illuminant C and the L, a and b values are the values according to the Lab system of Hunter.

As a variant, the second protective layer of TiOₓ was deposited from a metal target in an atmosphere of 20% oxygen instead of using a ceramic target, all else remaining equal. The properties obtained for the coated glazing are identical.

### EXAMPLE 2

The deposit of a coating is conducted by a deposition process identical in all aspects to the process described in Example 1, except that it is conducted on a glass sheet that is 6 mm thick instead of 4 mm.

The glazing provided with its coating is subjected to a thermal tempering operation, during which it is subjected to a temperature of 690° C. for 6 minutes, then cooled suddenly by jets of cold air. After this treatment, the coated and toughened glazing has the following properties when viewed from the layer side:
TL=87.4%; L=23.1; a=−1.3; b=−8.9; emissivity=0.05;
   the electrical surface resistivity of the coating is 3.7 ohm per square.

This coated glazing is then assembled as double glazing with another clear glass sheet of 4 mm, the coating being arranged on the side of the inside space of the double glazing. The following properties are noted when the double glazing is viewed from the layer side disposed in position 3:
TL=77.8%; L=34.0; a=−1.2; b=4.2.

Comparing Examples 1 and 2, it is found that with the same process of layer deposition with the same coating structure the change in the conditions of temperature and duration of the thermal tempering operation between the two examples has not significantly modified the optical, colorimetric and thermal properties. The method according to the invention therefore allows a stable coating to be formed, which is little dependent on the thermal treatment it is subjected to.

### EXAMPLE 3

The deposit of a coating is conducted by a deposition process identical in all aspects to the process described in Example 1, except that it is conducted on a glass sheet that is 8 mm thick instead of 4 mm.

The glazing provided with its coating is subjected to a thermal tempering operation, during which it is subjected to a temperature of 690° C. for 8 minutes, then cooled suddenly by jets of cold air. After this treatment, the coated and toughened glazing has the following properties when viewed from the layer side:
TL=86.4%; L=33.2; a=−1.6; b=−9.4; emissivity=0.05;
   the electrical surface resistivity of the coating is 3.6 ohm per square.

This coated glazing is then assembled as double glazing with another clear glass sheet of 4 mm, the coating being arranged on the side of the inside space of the double glazing. The following properties are noted when the double glazing is viewed from the layer side disposed in position 3:
TL=77.4%; L=34.0; a=−1.2; b=−4.0.

Comparing Examples 1 and 3, it is found that with the same process of layer deposition with the same coating structure the change in the conditions of temperature and duration of the thermal toughening operation between the two examples has not significantly modified the optical, colorimetric and thermal properties, although the period at elevated temperature was doubled. The method according to the invention therefore allows a stable coating to be formed, which is little dependent on the thermal treatment it is subjected to.

### EXAMPLE 4

In a magnetron type device for cathodic sputtering at reduced pressure, a coating is deposited on a 6 mm glass sheet in the following sequence. A first transparent dielectric layer is deposited that is formed by a 10 nm thick aluminium nitride layer followed by a layer of zinc oxide doped with 5% aluminium with a thickness of 20 nm. The aluminium nitride is deposited from an aluminium target in an atmosphere composed of 60% argon and 40% nitrogen. The zinc oxide is deposited from a target of zinc doped with 5% aluminium in an atmosphere formed from 70% oxygen and 30% argon. Then in a neutral atmosphere formed from 95% argon and 5% oxygen, a functional layer is deposited that is formed from 10.5 nm of silver doped with 1% palladium. In the same neutral atmosphere, a first protective layer formed from 0.8 nm of zinc is deposited, then a second protective layer formed from 4 nm of tantalum. A second transparent dielectric layer formed from 15 nm of zinc oxide doped with 5% aluminium is then deposited, followed by 17 nm of silicon nitride. The zinc oxide doped with aluminium is deposited in an oxidising atmosphere of 70% O₂ and 30% Ar, and Si₃N₄ is deposited in 40% Ar and 60% nitrogen.

The properties of the glazing coated after deposit are as follows when viewed from the layer side:
TL=84%; L=25; a=0; b=−12; emissivity=0.06.

This coated glazing is then assembled as double glazing with another clear glass sheet of 6 mm, the coating being arranged on the side of the inside space of the double glazing. The following properties are noted when the double glazing is viewed from the layer side disposed in position 3:
TL=75%; L=36; a=0; b=−6.

The single glazing provided with its coating is subjected to a thermal tempering operation, during which it is subjected to a temperature of 690° C. for 6 minutes, then cooled suddenly by jets of cold air. After this treatment, the coated and toughened glazing has the following properties when viewed from the layer side:
TL=86%; L=23; a=−1.; b=−10; emissivity=0.04;
   the electrical surface resistivity of the coating is 3.4 ohm per square.

Analysing the properties of the glazing, it is found that the coating has withstood the toughening operation very well without any degradation of the functional layer.

This coated and toughened glazing is then assembled as double glazing with another clear glass sheet of 6 mm, the coating being arranged on the side of the inside space of the double glazing. The following properties are noted when the double glazing is viewed from the layer side disposed in position 3:
TL=77%; L=34; a=−1; b=−5.

It is remarkable that the optical properties have practically not changed and that glazing units, either toughened or not, can be readily placed together on the same building.

### EXAMPLE 5

In a magnetron type device for cathodic sputtering at reduced pressure, a coating is deposited on a 2 mm thick glass sheet in the following sequence. A 30 nm thick first transparent dielectric layer is deposited that is formed by a mixed zinc-tin oxide deposited from a metal target of a zinc-tin alloy of 90% zinc, 10% tin, in an atmosphere of 100% oxygen. A functional layer of 10 nm silver is then deposited in a neutral atmosphere of 100% argon. A first protective layer of 0.7 nm of NiCr 80/20 is deposited on the silver layer in an atmosphere of 100% argon. On this first protective layer a second protective layer is disposed comprising 3 nm of TiOₓ working from a target of metallic titanium in an atmosphere of 20% oxygen. An intermediate transparent dielectric layer formed by 70 nm of ZnSnOₓ is then deposited in the same manner as the first transparent dielectric layer. The TiOₓ layer is completely oxidised by the plasma of the ZnSnOₓ deposit. A second functional layer of 10 nm of silver is deposited followed by 1.5 nm of a first protective layer of NiCr, the two layers being deposited in an atmosphere of 5% oxygen. Then, 2.5 nm of a second protective layer of TiOₓ from a metal target is deposited in 20% oxygen. The second transparent dielectric is formed by 20 nm of ZnSnOₓ deposited in 100% oxygen. The plasma of the deposit of the second dielectric completely oxidises the directly underlying TiOₓ layer. A final titanium-based protective layer of 3 nm is deposited to protect the coating.

The properties of the glazing coated after deposit are as follows when viewed from the layer side:
TL=60%; L=45; a =+3; b=+11; emissivity=0.05.

The glazing according to this example is intended to form a windscreen of a motor vehicle, wherein the coating assures solar protection to prevent excessive overheating in the passenger compartment.

The coated glazing is subjected to a bending operation at 650° C. for 12 minutes to give it the shape a windscreen must have.

After this treatment, the coated and bent glazing has the following properties viewed from the layer side:
TL=74%; L=39; a =+5; b=+9; emissivity=0.02;
   the electrical surface resistivity of the coating is 2.4 ohm per square, this being an advantageous value for serving as a heating layer.

The coated and bent glazing provided is assembled to form a laminated glazing with a 2 mm thick sheet of clear glass by means of a 0.76 mm PVB film.

The properties of the laminated glazing with the layer in position 2 (position 1 being the outside face in relation to the windscreen installed in the vehicle) are as follows:
TL=75.5%; L=35; a=−3.; b=−4; energy transmission TE according to Moon=45%; energy reflection according to Moon=34%;
   the light transmission being determined with respect to illuminant A here.

It is found that the coating has withstood the bending operation very well.

1. Method for the production of a glazing provided with a multilayer coating, said multiplayer coating being deposited on a glass substrate by cathodic sputtering at reduced pressure, characterised in that at least a first transparent dielectric layer is deposited on the substrate followed by the deposit of a functional layer based on an infrared reflective material, that in an atmosphere containing 20% oxygen at maximum, deposited on said functional layer is a first protective layer with a geometric thickness of 3 nm at maximum and composed of a material, of which the electronegativity different from oxygen is less than 1.9 and of which the electronegativity value is less than that of said infrared reflective material, followed by the deposit, in an atmosphere containing 50% oxygen at maximum, of a second protective layer with a geometric thickness of 7 nm at maximum and composed of a material, of which the electronegativity difference from oxygen is greater than 1.4, and that at least a second transparent dielectric layer is then deposited.

2. Method according to claim 1, characterised in that the first protective layer is composed of a material, of which the electronegativity difference from oxygen is less than 1.8 and preferably less than 1.7.

3. Method according to claim 1, characterised in that the second protective layer is composed of a material, of which the electronegativity difference from oxygen is greater than 1.6 and preferably greater than 1.8.

4. Method according to claim 1, characterised in that the electronegativity value of the material of the first protective layer is at least 0.05 less than that of the infrared reflective material.

5. Method according to claim 1, characterised in that the material of the second protective layer has a lower electronegativity value than the electronegativity value of the material of the first protective layer.

6. Method according to claim 5, characterised in that the material of the second protective layer has an electronegativity value at least 0.1, and preferably at least 0.2, less than the electronegativity value of the material of the first protective layer.

7-8. (canceled)

9. Method according to claim 1, characterised in that the first protective layer is NiCr-based, and preferably based on an NiCr 80/20 alloy.

10. Method according to claim 1, characterised in that the material of the second protective layer is selected from titanium, aluminium or tantalum, and preferably titanium.

11. Method according to claim 1, characterised in that the first protective layer is deposited in a thickness in the range of between 0.5 nm and 2.5 nm, preferably 0.5 nm and 2 nm, and advantageously between 0.6 nm and 1.5 nm.

12. Method according to claim 1, characterised in that the second protective layer is deposited in a thickness in the range of between 2 nm and 6 nm.

13-18. (canceled)

19. Method according to claim 1, characterised in that at least two functional layers based on an infrared reflective material are deposited, each followed by the deposit of first and second protective layers, and in that at least one intermediate dielectric layer is deposited between said functional layers.

20. Method according to claim 1, characterised in that a final titanium-based protective layer is deposited to terminate the multilayer coating.

21. Method for the production of a bent or toughened glazing provided with a multilayer coating, characterised in that a coated substrate obtained by the method according to claim 1 is then subjected to a bending or toughening operation.

22. Glazing provided with a multilayer coating, characterised in that it comprises a glass substrate, on which is deposited at least one functional layer based on an infrared reflective material, the functional layer or at least one of the functional layers being enclosed by at least one transparent dielectric layer, and that on its face opposite the substrate and directly in contact therewith, said functional layer is covered by a first protective layer with a geometric thickness of 3 nm at maximum and composed of a metal- or semi-metal-based material in metal, nitrided or sub-oxidised form, of which the electronegativity difference from oxygen is less than 1.9 and of which the electronegativity value is less than that of the infrared reflective material, followed by a second protective layer with a geometric thickness of 7 nm at maximum and composed of a material based on metal or semi-metal in substantially totally oxidised form, of which the electronegativity difference from oxygen is greater than 1.4 and which is different from the material of the transparent dielectric layer directly adjoining it.

23. (canceled)

24. Glazing according to claim 22, characterised in that the or at least one of the first protective layers is/are composed of a material, of which the electronegativity difference from oxygen is less than 1.8 and preferably less than 1.7.

25. Glazing according to claim 22, characterised in that the or at least one of the second protective layers is/are composed of a material, of which the electronegativity difference from oxygen is greater than 1.6 and preferably greater than 1.8.

26. Glazing according to claim 22, characterised in that the electronegativity value of the material of the or at least one of the first protective layers is at least 0.05 less than that of the infrared reflective material adjoining it.

27. Glazing according to claim 22, characterised in that the material of the or at least one of the second protective layers has a lower electronegativity value than the electronegativity value of the material of the first protective layer adjoining it.

28. Glazing according to claim 27, characterised in that the material of the or at least one of the second protective layers has an electronegativity value at least 0.1, and preferably at least 0.2, less than the electronegativity value of the material of the first protective layer adjoining it.

29. Glazing according to claim 22, characterised in that the or at least one of the functional layers is/are Ag-based, and that said first protective layer or layers is/are based on an alloy of Ni and Cr, and said second protective layer or layers is/are formed from titanium oxide.

30-32. (canceled)

33. Bent or toughened glazing provided with a multilayer coating, characterised in that it comprises a glass substrate, on which is deposited at least one functional layer based on an infrared reflective material, the functional layer or at least one of the functional layers being enclosed by at least one transparent dielectric layer, and that on its face opposite the substrate and directly in contact therewith, said functional layer is covered by a first protective layer with a geometric thickness of 3 nm at maximum and composed of a metal- or semi-metal-based material in oxidised or sub-oxidised form, of which the electronegativity difference from oxygen is less than 1.9, followed by a second protective layer with a geometric thickness of 7 nm at maximum and composed of a material based on metal or semi-metal in substantially totally oxidised form, of which the electronegativity difference from oxygen is greater than 1.4 and which is different from the material of the transparent dielectric layer directly adjoining it.

34. (canceled)

35. Glazing according to claim 33, characterised in that the or at least one of the first protective layers is/are composed of a material, of which the electronegativity difference from oxygen is less than 1.8 and preferably less than 1.7.

36. Glazing according to claim 33, characterised in that the or at least one of the second protective layers is/are composed of a material, of which the electronegativity difference from oxygen is greater than 1.6 and preferably greater than 1.8.

37. Glazing according to claim 33, characterised in that the electronegativity value of the material of the or at least one of the first protective layers is less than that of the infrared reflective material adjoining it, and preferably by at least 0.05.

38. Glazing according to claim 33, characterised in that the material of the or at least one of the second protective layers has a lower electronegativity value than the electronegativity value of the material of the first protective layer adjoining it.

39. Glazing according to claim 38, characterised in that the material of the or at least one of the second protective layers has an electronegativity value at least 0.1, and preferably at least 0.2, less than the electronegativity value of the material of the first protective layer adjoining it.

40. Glazing according to claim 33, characterised in that the functional layer is Ag-based, and that said first protective layer or layers is/are based on an alloy of Ni and Cr, and said second protective layer or layers is/are formed from titanium oxide, and that at least one of the dielectric layers contains a zinc-based oxide, preferably an oxide based on a zinc-tin alloy.

41-48. (canceled)
